(19) United States
(12) Patent Application Publication
(10) Pub. No.: US 2007/0148431 A1
(43) Pub. Date: Jun. 28, 2007

(54) QUATERNARY AMMONIUM COMPOUNDS WITH NOVEL MODE OF ACTION FOR PROTECTION OF WOOD STRUCTURES

(75) Inventors: Joe D. Sauer, Baton Rouge, LA (US); George W. Cook JR., Baton Rouge, LA (US); Christopher S. Knight, Prairieville, LA (US); Edmund F. Perkins JR., Baton Rouge, LA (US)

Correspondence Address: EDGAR SPIELMAN;ALBEMARLE CORPORATION, 451 FLORIDA BLVD., BATON ROUGE, LA, 70801, US

(73) Assignee: Albemarle Corporation, Baton Rouge, LA (US)

(21) Appl. No.: 11/613,312

(22) Filed: Dec. 20, 2006

Related U.S. Application Data
(60) Provisional application No. 60/864,276, filed on Nov. 3, 2006.
(60) Provisional application No. 60/864,272, filed on Nov. 3, 2006.
(60) Provisional application No. 60/773,241, filed on Feb. 13, 2006.
(60) Provisional application No. 60/752,275, filed on Dec. 20, 2005.
(60) Provisional application No. 60/752,349, filed on Dec. 20, 2005.

(51) Int. Cl. B32B 21/02; C08B 15/06

(52) U.S. Cl. 428/292.4; 536/30

(57) ABSTRACT

The present invention relates to cellulosic substrates in direct or indirect contact with the ground, the cellulosic substrates comprising quaternary ammonium compounds.

### CROSS-REFERENCE TO RELATED APPLICATIONS

The present application claims priority to U.S. Provisional Application No. 60/752,349 and U.S. Provisional Application No. 60/752,275, both filed Dec. 20, 2005; U.S. Provisional Application No. 60/773,241, filed Feb. 13, 2006; U.S. Provisional Application No. 60/864,272, filed Nov. 3, 2006; and U.S. Provisional Application No. 60/864,276, filed Nov. 3, 2006; all of which are hereby incorporated by reference in their entirety.

### FIELD OF THE INVENTION

The present invention relates to cellulosic substrates comprising quaternary ammonium compounds.

### BACKGROUND OF THE INVENTION

A class of molecules referred to as quaternary compounds or “quats” for short find use in many industrial applications. Quats are loosely defined as a group of compounds in which a nitrogen atom is joined to four organic radicals. Typically, but not always, one of the radicals is a long-chain alkyl group. In most industrial applications, these quat molecules are complexed with a counter ion (anion) to provide for an “active” molecule.

Industries that quats find utility in range from the wood preservative/biocide industry to such industries as hair care products, cleaning products, fabric softeners, pharmaceuticals, surfactants, deodorants, mouthwashes, preservatives, emulsifiers, cosmetics, and ore mining. Of special interest is the use of these quats as wood preservatives.

### SUMMARY OF THE INVENTION

The present invention relates to:
a) a cellulosic substrate; and
b) at least one quaternary ammonium compound having the formula: 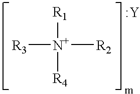
   wherein:
i) Y is selected from H₂BO₃⁻; HBO₃⁻²; BO₃⁻³; B₄O₇⁻²; HB₄O₇⁻; B₃O₅⁻; B₅O₈⁻²; BO₂⁻; PO₄⁻³, HPO₄⁻², H₂PO₄⁻, P₂O₇⁻⁴, P₃O₁₀⁻⁵, PO₃⁻; CO₃⁻²; HCO₃⁻; [CO₂⁻]ₙR₅; and combinations thereof, preferably H₂BO₃⁻; HBO₃⁻²; BO₃⁻³; B₄O₇⁻²; HB₄O₇⁻; B₃O₅⁻; B₅O₈⁻²; BO₂⁻; and combinations thereof;
ii) two of R₁, R₂, R₃ and R₄ are independently chosen from alkyl groups having from 1 to 4 carbon atoms;
iii) two of R₁, R₂, R₃ and R₄ is chosen from i) substituted or unsubstituted alkyl groups that contain from 1 to 20 carbon atoms or ii) substituted or unsubstituted alkenyl groups that contain from 1 to 20 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups;
iv) n is an integer equal to or greater than 1 and R₅ is chosen from substituted, unsubstituted, saturated, or unsaturated alkyl groups containing from 1 to 25 carbon atoms;
v) m is 1, 2, 3, 4, or 5 depending on the selection of Y; and
vi) said substrate is in direct or indirect contact with the ground.

In another embodiment the present invention relates to:
a) a cellulosic substrate; and
b) at least one quaternary ammonium compound having the formula:

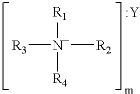

wherein Y is selected from H₂BO₃⁻; HBO₃⁻²; BO₃⁻³; B₄O₇⁻²; HB₄O₇⁻; B₃O₅⁻; B₅O₈⁻²; BO₂⁻; PO₄⁻³, HPO₄⁻², H₂PO₄⁻, P₂O₇⁻⁴, P₃O₁₀⁻⁵, PO₃⁻; CO₃⁻²; HCO₃⁻; [CO₂⁻]ₙR₅; and combinations thereof, preferably H₂BO₃⁻; HBO₃⁻²; BO₃⁻³; B₄O₇⁻²; HB₄O₇⁻; B₃O₅⁻; B₅O₈⁻²; BO₂⁻; and combinations thereof; R₁, R₂, R₃ and R₄ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, 3, 4, or 5 depending on the selection of Y; and said substrate is in direct or indirect contact with the ground.

In some embodiments, at least one, sometimes one and sometimes two, of R₁, R₂, R₃ and R₄ of the at least one quaternary ammonium compound is selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups.

### DETAILED DESCRIPTION OF THE INVENTION

The terms “microbial”, “microbe” and “microbial organism” can be used interchangeably herein and are used herein in the broadest sense and are meant to include one or more of the following: molds, mildews, funguses, and the like.

Also, “building” as used herein is also used in its broadest sense and is meant to include homes, office and/or other commercial buildings, storage units or buildings, apartments, mobile homes, travel trailers, detached garages, camps, and the like.

Quaternary Ammonium Compound

The term “quaternary ammonium compound”, “quat”, and “borate-quat” as used herein refer to a compound having the general formula R₁R₂R₃R₄—N⁺Y⁻, where the radicals may be the same, different, or part of a ring and Y is a counter anion. The organic radicals, i.e. R₁, R₂, R₃, and R₄, can be alkyl or alkenyl (unsaturated alkyls) groups that are linear or branched, substituted or unsubstituted, or mixtures thereof. The term “quaternary ammonium compound” or “quat” is also intended to encompass a compound in which one of the four organic radicals of a quat may be a “shared” radical with a second quat.

The quats of the present invention can be represented by the general formula:

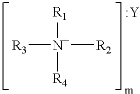

wherein Y is a counter anion, R₁, R₂, R₃, and R₄ are organic radicals, and m is 1, 2, 3, 4, or 5, all as described below.

The counter-anion of the quaternary ammonium compounds, Y, used in the present invention can be selected from borate anions, phosphate anions, carbonate anions (CO₃⁻²), bicarbonate anions (HCO₃⁻), and carboxylate anions ([CO₂⁻]ₙR₅). Thus, in some embodiments, Y is a borate anion, or a phosphate anion, or a bicarbonate anion, or a carbonate anion or carboxylate anions. In the case where two quaternary ammonium compounds are present, it is preferred that the counter anion of one of the quats is a bicarbonate anion and/or a carbonate anion, or a phosphate ion or a carboxylate anion, and the counter anion of the other quaternary ammonium compound is a borate anion.

Borate anions suitable for use herein include the dihydrogen borate anion, H₂BO₃⁻; the hydrogen borate anion, HBO₃⁻²; the borate anion, BO₃⁻³; the tetraborate anion, B₄O₇⁻²; the hydrogen tetraborate anion, HB₄O₇⁻; B₃O₅⁻; pentaborate, B₅O₈⁻²; and BO₂⁻. Thus, Y is suitably selected from H₂BO₃⁻; HBO₃⁻²; BO₃⁻³; B₄O₇⁻²; HB₄O₇⁻; B₃O₅⁻; B₅O₈⁻²; and BO₂⁻. If Y is a borate anion, in some embodiments, Y is BO₃⁻³, and m is 3.

Phosphate anions suitable for use herein include the phosphate anion, PO₄⁻³; the hydrogen phosphate anion, HPO₄⁻²; the dihydrogen phosphate anion, H₂PO₄⁻; the diphosphate anion, P₂O₇⁻⁴, and the triphosphate anion, P₃O₁₀⁻⁵. Thus, Y is suitably selected from PO₄⁻³, HPO₄⁻², H₂PO₄⁻, P₂O₇⁻⁴, P₃O₁₀⁻⁵, and PO₃⁻. If Y is a phosphate anion, in some embodiments, Y is PO₄⁻³, and m is 3.

Carboxylate anions suitable for use herein have the general formula [CO₂⁻]ₙR₅, wherein n is an integer equal to or greater than 1 and R₅ is chosen from substituted, unsubstituted, saturated, or unsaturated alkyl groups containing in the range of from about 1 to 25 carbon atoms. In some embodiments, R₅ contains in the range of from about 10 to about 20 carbon atoms, in some embodiments in the range of from 10 to 12 carbon atoms, in other embodiments in the range of from 12 to 14 carbon atoms, in other embodiments in the range of from 12 to 14 carbon atoms, in other embodiments in the range of from 14 to 16 carbon atoms, and in still other embodiments in the range of from 16 to 18 carbon atoms.

The four carbon chains, i.e. R₁, R₂, R₃ and R₄, of the quats used in the present invention are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups. Alkyl and alkenyl groups suitable for use in the quats are those that contain in the range of from 1 to 20 carbon atoms. In some embodiments, R₁ and R₂ are independently chosen from alkyl groups having in the range of from 1 to 3 carbon atoms, and R₃ and R₄ are independently chosen in the range of from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, or 3. In another embodiment, R₁ and R₂ are methyl groups and R₃ and R₄ are independently selected from unsubstituted alkyl groups containing in the range of from 8 to 14 carbon atoms. In one embodiment, one of R₃ or R₄ is an unsubstituted alkyl group containing in the range of from 8 to 10 carbon atoms, and one of R₃ or R₄ is an unsubstituted alkyl group containing in the range of from 12 to 14 carbon atoms. In some of the embodiments, R₃ and R₄ do not contain the same number of carbon atoms. In still other embodiments, R₁, R₂, R₃ and R₄ are alkyl groups having in the range of from 1 to 3 carbon atoms, sometimes methyl groups.

In other embodiments of the present invention, at least one, sometimes only one and in other embodiments only two, of the four carbon chains, i.e. R₁, R₂, R₃ and R₄, is selected from i) substituted or unsubstituted alkyl groups that contain from 13 to 16, sometimes 14 to 16, sometimes 14, carbon atoms or ii) substituted or unsubstituted alkenyl groups that contain from 13 to 16, sometimes 14 to 16, sometimes 14, carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups. These carbon chains can be saturated or unsaturated, preferably unsubstituted. In these embodiments, these carbon chains are selected from unsaturated substituted or unsubstituted, preferably unsubstituted, alkyl groups containing from 13 to 16, sometimes 14 to 16, sometimes 14, carbon atoms. In these embodiments, at least two, in some embodiments only two, and in other embodiments three, of R₁, R₂, R₃ and R₄ are independently chosen from alkyl groups having from 1 to 4, preferably 1 to 3, in some embodiments 2 to 4, carbon atoms. In these embodiments, it is also contemplated that one of R₁, R₂, R₃ and R₄ be selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups. The alkyl and alkenyl groups are those that contain from 1 to 20 carbon atoms. In some embodiments, one of R₁, R₂, R₃ and R₄ is chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, or 3. In some embodiments, it is selected from unsubstituted alkyl groups containing from 8 to 14 carbon atoms. In other embodiments, it is selected from unsubstituted alkyl group containing from 8 to 10 carbon atoms, and in other embodiments, it is selected from unsubstituted alkyl groups containing from 12 to 14 carbon atoms. In some of the embodiments, the at least one, sometimes only one and in other embodiments only two, of the four carbon chains, does not contain the same number of carbon atoms as the other three carbon chains.

In some embodiments of the present invention, two of the four carbon chains are independently selected from alkyl groups having from 1 to 4, sometimes 1 to 3, in some embodiments 2 to 4, carbon atoms, and two of the four carbon chains be independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, 3, 4, or 5, wherein ranges as described above are contemplated and the two of the four carbon chains independently chosen from 6 to 20 carbon atom-containing groups contain different numbers of carbon atoms.

In another embodiment, m is 2, and one of the four organic radicals of a quat may be a “shared” radical with a second quat. It should be noted that while in this embodiment R₄ is shown as the shared radical, the shared radical can be any of R₁, R₂, R₃, or R₄. In this embodiment, the quaternary ammonium compounds used in the coating formulations of the present invention have the general formula:

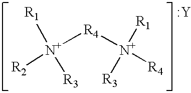

In this embodiment, R₁, R₂, R₃, R₄, are as described above, and Y is selected from those anions described above having an ionic charge of −2, in some embodiments a borate anion having an ionic charge of −2, in some embodiments, HBO₃⁻².

In another embodiment when m is 2, and one of the four organic radicals of a quat may be a “shared” radical with a second quat, the quaternary ammonium compounds used in the present invention have the general formula:

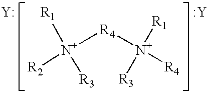

In this embodiment, R₁, R₂, R₃, R₄ are as described above, and Y is independently selected from those anions described above having an ionic charge of −1, in some embodiments from borate anions having an ionic charge of −1 (H₂BO₃⁻; HB₄O₇⁻; B₃O₅⁻; and BO₂⁻), in other embodiments each Y is H₂BO₃⁻. It should be noted that while in this embodiment R₄ is shown as the shared radical, the shared radical can be any of R₁, R₂, R₃, or R₄.

In another embodiment m is 3, and one of the four organic radicals of a quat is a “shared” radical with a second quat. In this embodiment, the quaternary ammonium compounds used in the coating formulations of the present invention can have the general formula:

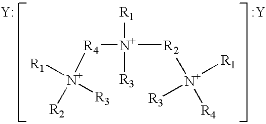

In this embodiment, R₁, R₂, R₃, and R₄ are as described above, and one Y is independently selected from the counter-anions described above having an ionic charge of −2 and the other Y is selected from those counter-anions having an ionic charge of −1. In some embodiments, one Y is selected from H₂BO₃⁻; HB₄O₇⁻; B₃O₅⁻; and BO₂⁻ and the other Y is selected from HBO₃⁻²; B₄O₇⁻²; and B₅O₈⁻². It should be noted that while in this embodiment R₄ is shown as the shared radical, the shared radical can be any of R₁, R₂, R₃, or R₄.

In another embodiment when m is 3, and one of the four organic radicals of a quat may be a “shared” radical with a second quat, the quaternary ammonium compounds used in the present invention have the general formula:

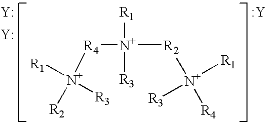

In this embodiment, R₁, R₂, R₃, and R₄ are as described above, and each Y is independently selected from those anions having a net ionic charge of −1. In some embodiments, each Y is independently selected from H₂BO₃⁻; HB₄O₇⁻; B₃O₅⁻. It should be noted that while in this embodiment R₄ is shown as the shared radical, the shared radical can be any of R₁, R₂, R₃, or R₄.

In some embodiments, m is 3 and Y is BO₃⁻³. In these embodiments, the quaternary ammonium compounds used in the present invention have the general formula:

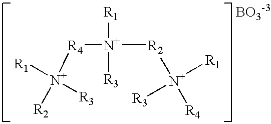

In this embodiment, R₁, R₂, R₃, or R₄ are as described above. It should be noted that while in this embodiment R₄ and R₂ are shown as the shared radicals, the shared radicals can be independently any of R₁, R₂, R₃, or R₄ or any combinations thereof. For example, R₄ and R₁ can be the shared radicals, R₁ and R₃ can be the shared radicals, etc. Also, all three nitrogen atoms can share the same radical group, independently selected from R₁, R₂, R₃, or R₄.

The inventors hereof have unexpectedly discovered that the quat(s) of the present invention are effective at imparting at least anti-microbial properties to substrates, especially wood. Also, while the prior art teaches that carbonate and/or bicarbonate quats are termiticides, the inventors of the present invention have discovered that some of the quats, e.g. borate-quats, used in the present invention are effective at repelling termites. By repelling termites, it is meant that the termites do not feed on the quat-treated cellulosic substrate, will crawl across the quat-treated cellulosic substrate without feeding on it, and sometimes resort to cannibalistic behavior for food instead of feeding on the quat-treated cellulosic material. The inventors hereof, while not wishing to be bound by theory, believe that the termites do not recognize the treated cellulosic substrate as a food source. In some embodiments, the quats of the present invention are effective at imparting some flame retardant properties to the quat-treated cellulosic materials.

Also, if Y is a borate, the inventors hereof have discovered that the quats are less susceptible to leaching than quats containing a different counter-anion Y. By less susceptible to leaching, it is meant that an effective amount, as defined above, of the borate-quats remain in the cellulosic material after exposure, i.e. rain, washing, etc., to water. In some embodiments, an effective amount remains after repeated, i.e. more than 2, exposures to water. Because the borate-quats are less susceptible to leaching, the borate-quat treated cellulosic material maintains its fungicidal properties for a length of time longer that the traditional carbonate/bi-carbonate quat treated substrates. Thus, in the case of carbonate and bicarbonate quats and their combination, fungus grows on the surface of cellulosic material treated with these quats more readily than on cellulosic material treated with the same amount of borate-quats according to the present invention. The inventors hereof have determined that this property is critical to the prolonged termite repellency of the borate-quat treated cellulosic material. While not wishing to be bound by theory, the inventors hereof theorize that this fungus growth more rapidly degrades the concentration of the carbonate/bi-carbonate quat treatment, thus causing cellulosic material treated with these quats to lose desired termiticide properties. However, the termite repellant properties of cellulosic material treated with the borate-quats of the present invention does not degrade in a similar manner because fungus growth does not occur as readily.

The quats of the present invention can be prepared by any methods known in the art, exemplary methods include those described in commonly-owned co-pending applications PCT US2005/010162 and U.S. 60/730,821, which are incorporated herein by reference in their entirety. In some embodiments, the quats are produced using an ion exchange technologies.

Cellulosic Substrate

Cellulosic substrate as used herein is meant to refer to wood, cotton, cardboard, liner board; other similar paper products; paper “coverings” on wall boards such as gypsum board; ceiling tile materials; composite assemblies; particleboard or other similar composite or engineered material used in the construction of a building, i.e. fiber board, press-board, and the like; any other material made of cellulose, any combinations thereof; and the like. In some embodiments, the cellulosic substrate is wood, or particleboard or other similar composite or engineered wood material used in the construction of a building, i.e. fiber board, press-board, and the like.

In the present invention, the cellulosic substrates are in direct contact with the ground, i.e. soil; in other embodiments, the cellulosic substrates are in indirect contact with the ground. Indirect contact as used herein is meant that the cellulosic substrate may be on top of, for example, a cement or similar pad or slab for a building, may be roof beam of a building wherein the wooden or metal studs of the building are in contact with the ground or a slab, etc. In some embodiments, the cellulosic substrate is a part of a building, sometimes a building in construction and sometimes a completed building. In some embodiments, the cellulosic substrate is in an environment conducive to the presence, growth, and/or sustainability of termites. In other embodiments, the building is in an environment conducive to the presence, growth, and/or sustainability of termites.

The cellulosic substrate(s) can be treated or impregnated with the quats of the present invention according to any method known in the art. Non-limiting examples of ways of treating and/or impregnating substrates include dipping, soaking, brushing, pressure treating, and the like. The length of treatment time will vary according to the treatment method selected, the substrate, and the desired properties. Treatment times are readily selectable by one having ordinary skill in the art.

However, all treatments generally involve treating the cellulosic substrate with an aqueous solution comprising the quat(s) until the treated cellulosic substrate comprises an effective amount of the quat(s). By an effective amount, it is meant that the treated cellulosic substrate comprises from about 1 to about 30 wt. %, based on the weight of the treated cellulosic substrate, of the quat(s). In preferred embodiments, the treated cellulosic substrate comprises from about 5 to about 10 wt. % of the quat(s), on the same basis.

In the practice of the present invention the aqueous solution used in the treatments of the cellulosic substrate is metal coupler free. By metal coupler free, it is meant that the aqueous solution does not contain metals such as copper, mercury, lead, cadmium, hexavalent chromium, arsenic, antimony, or zinc. These metals are commonly used for their biocidal properties. However, these and other “heavy” metals pose certain environmental concerns, thus, it would be beneficial to provide a treated cellulosic material that does not contain these heavy metals. By this, it is meant that the treated cellulosic material does not contain heavy metals that are not naturally present in the cellulosic material, i.e. these heavy metals are not added to the cellulosic material but may naturally be present in the cellulosic material.

The processes used in the production of quats, for example those described in commonly-owned co-pending applications PCT US 2005/010162and U.S. 60/730,821, typically produce quats in an aqueous solution. The aqueous solution typically comprises water, at least one polar organic co-solvent, and one or more quats, as described herein. These aqueous solutions generally have a polar organic co-solvent to water ratio in the range of from about 10:90 up to about 99:1 (wt. co-solvent:wt. water based on the combination of the water and polar organic co-solvent), and the exact amount of the polar organic co-solvent and water is selected according to the selection of R₁, R₂, R₃ and R₄. In general, it is preferred that the ratio of co-solvent:water, by weight and on the same basis, is within the range of from about 50:50 to about 99:1, about 60:40 to about 99:1 is more preferred, about 70:30 to about 98:2 is even more preferred, and about 80:20 to about 95:5 is yet more preferred.

It has generally been found that aqueous solutions having a higher ratio of co-solvent to water are preferred for quats containing very hydrophobic alkyl substituent groups, e.g., double tailed or twin tailed quats where the alkyl groups are C₁₀-C₂₀, for example, while aqueous solutions having a lower ratio of co-solvent to water are preferred for boron-quats having less hydrophobic alkyl substituent groups, e.g., a (C₂-C₆) alkyltrimethlylammoniun salt.

It should be understood that the aqueous solutions comprise water, at least one polar organic co-solvent and the quat(s) according to the present invention. However, when describing the amount of water and polar organic co-solvent in the aqueous solution above, these ratios were based on the amount of polar organic co-solvent and water. Thus, when considering the amounts of these components and the quat in the prophylactic solution, the mixture is a ternary composition comprising at least three major components, water, polar organic co-solvent, and the quat “salt”. Thus, the ratio of the components of the aqueous solution can be represented as a ratio of wt. quat:wt. polar organic co-solvent:wt. water, based on the aqueous solution. By way of example, an aqueous solution formed by adding 25% by weight of a quat salt to a mixture comprising an 85:15 by weight mixture of methanol:water, would have a ternary composition, by weight, of 25:64:11, quat salt:methanol:water by weight, based on the aqueous solution.

Because of economic and/or process considerations the quats are generally produced in an aqueous solutions generally have a concentration of quat(s) ranging front about 1 to about 50 wt. % quat, based on the aqueous solution. If the quat concentration of the aqueous solution is in the range of from about 1 to about 10 wt. %, based on the aqueous solution, then the aqueous solutions can be applied to the cellulosic substrate as is, but these aqueous solutions are generally only available commercially with quat concentrations in the range of from about 10 to about 30 wt. %, based on the aqueous solution, of the quat(s), more typically in the range of from about 20 to about 30 wt. %, on the same basis. The inventors hereof have discovered that quat(s) concentrations this high are not necessary and ranges much lower are effective and less costly at producing a treated cellulosic substrate containing an effective amount of quat(s), as described above. Thus, in the practice of the present invention, a diluent can be added to the aqueous solution to reduce the quat concentration of the aqueous solution to within the range of from about 1 to about 10 wt. %, in some embodiments in the range of from about 2 to about 8 wt. %, and in some embodiments in the range of about 4 to about 6 wt. %, all based on the aqueous solution. Diluents suitable for use herein can be selected from polar organic co-solvents, as described above, water, and mixtures thereof. In some embodiments, the diluent is water.

### Alternative Embodiments

In one embodiment, the present invention can comprise one, in some embodiments more than one, quaternary ammonium compound having the formula:

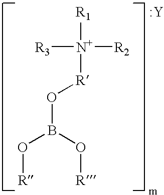

wherein R₁, R₂, R₃, Y, and m are as described above, R′ is a hydrocarbon group having from 1-10 carbon atoms, sometimes 1-5, sometimes 1-3, and R″ and R′″ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups. Preferably R″ and R′″ are selected from unsubstituted alkyl groups having from 1-20 carbon atoms, preferably 1-15, and more preferably 6-14.

In another embodiment, the present invention comprises a cellulosic substrate and a first and second, sometimes a third, quaternary ammonium compound. In another embodiment, a first and second quaternary ammonium compound are used in the practice of the present invention. The first quaternary ammonium compound can have any of the formulas described above, but in some embodiments the first quaternary ammonium compound be characterized by the formula:

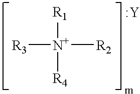

wherein m is as described above, and Y is selected from borates, as described above including preferred embodiments. In this embodiment, the four carbon groups, i.e., R₁, R₂, R₃ and R₄, of the first quaternary ammonium compound are selected from those described above, including preferred embodiments.

In this embodiment, the second quaternary ammonium compound can have any of the formulas described above, but in some embodiments that the second quaternary ammonium compound be characterized by the formula:

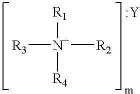

wherein m is as described above, and Y is selected from a counter-anion other than borate, i.e. carbonates and/or bicarbonates, phosphates, carboxylates, and mixtures thereof, in some embodiments carbonates and/or bicarbonates. In this embodiment, the four carbon groups, i.e., R₁, R₂, R₃ and R₄, of the second quaternary ammonium compound are selected from those described above.

It is within the scope of the present invention that when Y of the second quaternary ammonium compound is bicarbonate or carbonate, that a third quaternary ammonium compound having the same general formula as the second quaternary ammonium compound be present. In this embodiment, the third quaternary ammonium compound is metal coupler free, and the four carbon groups, i.e., R₁, R₂, R₃ and R₄, of the third quaternary ammonium compound are selected from those described above. In this embodiment, the Y counter-anion of the third quaternary ammonium compound is bicarbonate or carbonate, but not the same as the second quaternary ammonium compound. For example, if Y of the second quaternary ammonium compound is carbonate, the Y of the third quaternary ammonium compound is bicarbonate, and vice versa.

The above description is directed to several embodiments of the present invention. Those skilled in the art will recognize that other embodiments, which are equally effective, could be devised for carrying out the spirit of this invention. It should also be noted that preferred embodiments of the present invention contemplate that all ranges discussed herein include ranges from any lower amount to any higher amount.

The following examples will illustrate the present invention, but are not meant to be limiting in any manner.

### EXAMPLES

### Example 1

In order to prove the effectiveness and retention of the quats according to the present invention, wood (southern yellow pine) samples having the measurements of 1.8×1.8×0.6 were treated with the following solutions:

TABLE 1

| Wood Treatment | Concentration of Active Ingredient |
|---|---|
| Borate-Quat | 23.8 wt. % borate-quat, based on the |
| | solution |
| Metal coupler free | 50 wt. %, based on the solution |
| Carbonate/Bicarbonate | |
| Quaternary Ammonium | |
| compound | |
| Tim-Bor ® | 98 wt. % disodium octaborate tetrahydrate |
| Bora-Care | 40 wt. % disodium octaborate tetrahydrate |
| Deionized water (pH 6) | N/A |

Each of the wood treatments in Table 1 was individually diluted in deionized water to provide for a wood treatment solution comprising 5 wt. %, based on the solution, of the wood treatment. Each solution was then used to treat 40 samples as described above.

The 40 samples were treated with the wood treatment solution by placing them into 400 ml of the wood treatment solution and shaking them on a shaker for 24 hours. The samples were then dried in a hood for 24 hours and stored in wrapped aluminum foil for 24 hours.

Six (“6”) samples were then randomly chosen from each treatment. The 6 samples from each treatment were separately placed in 50 ml of deionized water and shaken on a shaker for 24 hours. This process was repeated two times for a total of 3 water-washes. After the third and final water-washing step, the wood pieces were allowed to dry in a hood from 5 days.

After the fifth day of drying, the samples were subjected to termites according to the single choice standard method of the American Wood-Preservers' Association. Glass screw-top jars (80 mm in diameter and 150 mm in height) were used, each containing 150 g of washed and autoclaved sand moistened with 30 ml distilled water.

### Example 2

In this example, the retention of quats were compared to that of Tim-Bor®, 98 wt. % disodium octaborate tetrahydrate, a common termite treatment. In this example 10 samples of wood (southern yellow pine) as described above were soaked in 100 ml 5% solutions of borate-quat and Tim-Bor®, prepared as described above. The 5% solutions were prepared from borate-quat and Tim-Bor® wood treatments as described in Table 1.

The samples were treated with the wood treatment solution by placing them into 100 ml of the wood treatment solution and shaking them on a shaker for 24 hours. The samples were then dried in a hood for 24 hours and stored in wrapped aluminum foil for 24 hours.

Each sample was then placed in numbered 100×15 mm Petri dishes containing 50 g of sand moistened with 6 ml of 6 pH deionized water. 200 formosan termites (180 workers and 20 soldiers) were placed into each dish and the dishes were placed in an incubator at 28° C. Water was added to the petri dishes as necessary. When termite mortality was near 100% in the Tim-Bor® treated samples, the experiment was stopped. Daily observations were taken concerning tunneling, mortality, and termite location (on/off the wood).

After 14 days, about 90% termite mortality was observed in the Tim-Bor® treated-sample Petri dishes. After 4 weeks, 100% mortality was achieved in the Tim-Bor® treated wood, and the experiment was stopped. During the course of the experiment, the termites remained on the Tim-Bor® treated wood and surface of the sand surrounding it. The termites, as expected, ate the Tim-Bor® treated samples and died.

However, the termites in the Petri dishes containing the borate-quat treated samples did not eat the wood samples. Instead, these termites stayed away from the wood pieces and tunneled into the sand. At the end of these experiments, live termites were present in 2 of the 10 Petri dishes containing the borate-quat treated samples. In one dish 49 workers remained, and in the other dish 2 workers remained. They were removed from the dishes, and observed to have flattened abdomens and appeared shrunken, due to their lack of feeding while in the dishes. In fact, during the experiment, dead termites had to be removed from the dishes because of cannibalistic behavior.

Therefore, this example proves that borate-quat is not a termiticide, but a termite repellant. Termites do not eat wood treated with borate-quats according to the present invention, and in fact do not recognize the wood as a food source as evidenced by their tunneling behavior.

### Example 3

In order to show the superior retention of the quats according to the present invention, the samples from Example 2 above were removed from the Petri dishes and subjected to another water-washing step as described in Example 2. These samples were then placed in Petri dishes and termites added, as described in Example 2. After 14 days, very little termite mortality was observed in the Tim-Bor® treated wood samples, and termite activity was as observed in Example 2, i.e. termites on the surface of the samples, on the sand and eating the samples.

The termites in the Petri dishes containing the borate-quat treated also behave the same. They did not eat the wood, and continued to tunnel instead of remaining on the surface. This indicates that borate-quat does not leach and is instead retained in the wood. Thus, borate-quat containing wood treatments are termite repellants and are less susceptible to leaching than traditional termite treatments.

### Example 4

In order to show the superior fungicidal effectiveness of the quats according to the present invention, wood chips were treated with the materials outlined in Table 1, above. Wood chips were separately treated with a 5% water solution of the wood treatments, prepared as described above. The wood chips were treated with the solution as described in example 2, i.e. shaken and dried in a hood.

The treated wood chips were soaked in water having a pH of 5 for 20 minutes, and they were the autoclaved at a sufficient temperature. The treated wood chips were placed in separate Petri dishes, and a loopful of gloeophyllum trabeum was then transferred onto the wet autoclaved chips aseptically. The Petri dishes were then sealed with parafilm® and incubated at 25° C. for a sufficient amount of time. This experiment was repeated three times with three different groups of wood chips being treated in identical manners with identical solutions.

In each experiment, after a sufficient amount of time, the wood chip were transferred to potato dextrose yeast agar medium to determine the survival of the gloeophyllum trabeum. The gloeophyllum trabeum was alive and active on all of the water-only treated wood chips. On the borate-quat, Borocare and Tim-Bor® treated chips, all of the gloeophyllum trabeum was dead. However, in one of the three metal coupler free carbonate/bicarbonate trials, mycelial growth of the gloeophyllum trabeum was observed. Thus, this indicates that borate-quats according to the present invention are more effective fungicides than metal coupler free carbonate/bicarbonate quaternary ammonium compounds.

### Example 5

In this example, the ability to provide some flame retardancy to a cellulosic substrate was explored by using “fireplace matches” 11 inches long as test samples.

Three matches at a time were treated by immersing the set of three matches in a 10 mL cylinder holding 8.0 mL of treatment solution, as described in Table 2 below. When the matches were immersed, the treatment fluid level was at the top of the cylinder and this left approximately 4 inches of wood (the match head end) untreated.

TABLE 2

| | | Fluid | Fluid | |
|---|---|---|---|---|
| | | Initial | Final | Treat |
| Code | Treatment ID | Volume | Volume | Time |
| 1-Black | jds-9087-15-1/tap water | 8 ml | 7.5 ml | 5 minutes |
| 2-Black | jds-9087-15-2/tap water | 8 ml | 7.5 ml | 10 minutes |
| 1-red | Jds-9087-15-3; solution jds- | 8 ml | 6.5 ml | 5 minutes |
| | 9087-11-1 (31.7% active | | | |
| | [1.1.1.1]N+ Borate- in water) | | | |
| 2-red | jds-9087-15-4; solution jds- | 8 ml | 6.5 ml | 10 minutes |
| | 9087-11-2 (31.7% active | | | |
| | [1.1.1.1]N+ Borate- in a | | | |
| | water, 10 wt. %, based on | | | |
| | the solution, | | | |
| | methanol solution) | | | |

After each treatment step, the treated matches were removed from the cylinder and placed on absorbent paper to remove any excess fluid. All of the treated matches were then air dried at ambient conditions for 30 min, and they were then placed in a conventional oven preheated at 175° F. for 5 minutes to complete drying.

To evaluate the “treatment” as a flame retardant, a match from each type of treatment was held, untreated/match head end down at a 45° angle and the match head was ignited by use of a butane lighter. The lighter was removed and the match was allowed to burn.

It was observed that the matches treated with treatment ID jds-9087-15-1 and jds-9087-15-2 burned completely to the end of the match stick with no surviving, unburned wood remaining.

However, the matches treatment jds-9087-15-3 and jds-9097-15-4 both burned as above examples until the flame reached the “treatment” line (approximately 4 inches from the end) at which point the flame auto-extinguished and the remaining, treated wood was unburned.

What is claimed:

1) Cellulosic substrates comprising:
a) a cellulosic substrate; and
b) at least one quaternary ammonium compound having the formula: 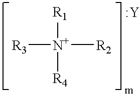
wherein:
i) Y is selected from H₂BO₃⁻; HBO₃⁻²; BO₃⁻³; B₄O₇⁻²; HB₄O₇⁻; B₃O₅⁻; B₅O₈⁻²; BO₂⁻; PO₄⁻³, HPO₄⁻², H₂PO₄⁻, P₂O₇⁻⁴, PO₁₀⁻⁵, PO₃⁻; CO₃⁻²; HCO₃⁻; [CO₂⁻]ₙR₅; and combinations thereof;
ii) two of R₁, R₂, R₃ and R₄ are independently chosen from alkyl groups having from 1 to 4 carbon atoms;
iii) two of R₁, R₂, R₃ and R₄ is chosen from i) substituted or unsubstituted alkyl groups that contain from 1 to 20 carbon atoms or ii) substituted or unsubstituted alkenyl groups that contain from 1 to 20 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups;
iv) m is 1, 2, 3, 4, or 5 depending on the selection of Y;
v) n is an integer equal to or greater than 1 and R₅ is chosen from substituted, unsubstituted, saturated, or unsaturated alkyl groups containing from 1 to 25 carbon atoms; and
vi) said cellulosic substrates are in direct or indirect contact with the ground.

2) The cellulosic substrates according to claim 1 wherein said cellulosic substrates comprise in the range of from about 1 to about 30 wt. %, based on the weight of the cellulosic substrate, of the at least one quaternary ammonium compound.

3) The cellulosic substrates according to claim 2 wherein R₁ and R₂ are independently chosen from alkyl groups having in the range of from 1 to 3 carbon atoms, and R₃ and R₄ are independently chosen from 6 to 20 carbon-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups.

4) The cellulosic substrates according to claim 3 wherein R₁ and R₂ are methyl groups and R₃ and R₄ are independently selected from unsubstituted alkyl groups containing from 8 to 16 carbon atoms.

5) The cellulosic substrates according to claim 4 wherein the carbon atom containing group of R₃ has a different number of carbons than the carbon atom containing group of R₄.

6) The cellulosic substrates according to claim 3 wherein one of R₃ or R₄ is an unsubstituted alkyl group containing in the range of from 8 to 10 carbon atoms, and one of R₃ or R₄ is an unsubstituted alkyl group containing in the range of from 12 to 16 carbon atoms.

7) The cellulosic substrates according to claim 3 wherein one of R₃ or R₄ is an unsubstituted alkyl group containing from 8 to 10 carbon atoms, and one of R₃ or R₄ is an unsubstituted alkyl group containing in the range of from 12 to 14 carbon atoms.

8) The cellulosic substrates according to claim 1 wherein Y is BO₃⁻³, and m is 3.

9) The cellulosic substrates according to claim 1 wherein at least one of R₁, R₂, R₃, and R₄ is a shared radical.

10) The cellulosic substrates according to claim 9 wherein i) m is 2, and ii) Y is selected from HBO₃⁻²; B₄O₇⁻²; and B₅O₈⁻².

11) The cellulosic substrates according to claim 9 wherein i) m is 3, ii) said quaternary ammonium compound contains 2 shared anions Y, and iii) one of the shared anions is selected from H₂BO₃⁻; HB₄O₇^{-; B}₃O₅⁻; and BO₂⁻ and the other shared anion is selected from HBO₃⁻²; B₄O₇⁻²; and B₅O₈⁻².

12) The cellulosic substrates according claim 9 wherein i) m is 3, and ii) said quaternary ammonium compound contains 3 shared anions Y, each Y independently selected from H₂BO₃⁻; HB₄O₇⁻; B₃O₅⁻; and BO₂⁻.

13) The cellulosic substrates according to claim 2 wherein said at least one quaternary ammonium compound has the formula: 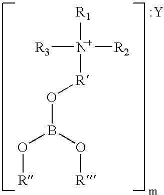
wherein Y is selected from H₂BO₃⁻; HBO₃⁻²; BO₃⁻³; B₄O₇⁻²; HB₄O₇⁻; B₃O₅⁻; B₅O₈⁻²; BO₂⁻; PO₄⁻³, HPO₄⁻², H₂PO₄⁻, P₂O₇⁻⁴, P₃O₁₀⁻⁵, PO₃⁻; CO₃⁻²; HCO₃⁻; [CO₂⁻]ₙR₅; and combinations thereof; R₁, R₂, R₃ and R₄ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, 3, 4, or 5, depending on the selection of Y; R′ is a hydrocarbon group having from 1-10 carbon atoms; and R″ and R′″ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups.

14) The cellulosic substrates according to claim 2 wherein said cellulosic substrate comprises a first, second, and optionally a third, quaternary ammonium compound wherein:
a) said first quaternary ammonium compound characterized by the formula: 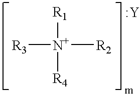
wherein Y is selected from H₂BO₃⁻; HBO₃⁻²; BO₃⁻³; B₄O₇⁻²; HB₄O₇⁻; B₃O₅⁻; B₅O₈⁻²; and BO₂⁻; R₁, R₂, R₃ and R₄ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, 3, 4, or 5, depending on the selection of Y; and
b) said second quaternary ammonium compound is characterized by the formula: 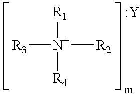
wherein Y is selected from PO₄⁻³, HPO₄⁻², H₂PO₄⁻, P₂O₇⁻⁴, P₃O₁₀⁻⁵, PO₃⁻; CO₃⁻²; HCO₃⁻; [CO₂⁻]ₙR₅; and combinations thereof; R₁, R₂, R₃ and R₄ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, 3, 4, or 5, depending on the selection of Y.

15) The cellulosic substrates according to claim 14 wherein each R₁ and R₂ of said first and second quaternary ammonium compound is independently chosen from alkyl groups having in the range of from 1 to 3 carbon atoms, and each R₃ and R₄ of said first and second quaternary ammonium compounds are independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups.

16) The cellulosic substrates according to claim 15 wherein R₃ of said first quaternary ammonium compound has a different number of carbons than R₄ of said first quaternary ammonium compound.

17) The cellulosic substrates according to claim 16 wherein R₃ of said second quaternary ammonium compound has a different number of carbons than R₄ of said second quaternary ammonium compound.

18) The cellulosic substrates according to claim 8 wherein the cellulosic substrates are termite repellant and/or flame retardant.

19) The cellulosic substrates according to claim 9 wherein the cellulosic substrates are termite repellant and/or flame retardant.

20) The cellulosic substrate according to claim 14 wherein the cellulosic substrates are termite repellant and/or flame retardant.

21) The cellulosic substrates according to claim 8 wherein said cellulosic substrates are part of a building in any stage of its construction.

22) The cellulosic substrate according to claim 8 wherein said cellulosic substrates are a part of or present in a completed building.

23) The cellulosic substrates according to claim 14, wherein said cellulosic substrate comprises said optional third quaternary ammonium compound; the counter anion Y of said second quaternary ammonium compound is CO₃⁻²; and the third quaternary ammonium compound is characterized by the formula: 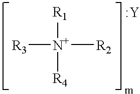
wherein Y is HCO₃⁻; R₁, R₂, R₃ and R₄ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1.

24) The cellulosic substrates according to 23 wherein R₃ of said third quaternary ammonium compound has a different number of carbons than R₄ of said third quaternary ammonium compound.

25) The cellulosic substrates according to claim 24 wherein said cellulosic substrates are part of a building in any stage of its construction.

26) The cellulosic substrates according to claim 13 wherein said cellulosic substrates are part of a building in any stage of its construction.

27) The cellulosic substrates according to claim 25 wherein said quaternary ammonium compound has been applied to said cellulosic substrate through the use of a metal coupler free solution comprising said quaternary ammonium compound.

28) The cellulosic substrates according to claim 26 wherein said quaternary ammonium compound has been applied to said cellulosic substrate with a metal coupler free solution comprising said quaternary ammonium compound.

29) The cellulosic substrates according to claim 1 wherein said treated cellulosic substrate is flame retardant.

30) The cellulosic substrates according to claim 5 wherein according to claim 1 wherein Y is BO₃⁻³, and m is 3.

31) The cellulosic substrates according to claim 14 wherein said cellulosic substrates are part of a building in any stage of its construction

32) A composition comprising:
a) a cellulosic substrate; and
b) at least one quaternary ammonium compound having the formula: 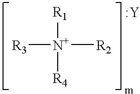
wherein Y is selected from H₂BO₃⁻; HBO₃⁻²; BO₃⁻³; B₄O₇⁻²; HB₄O₇⁻; B₃O₅⁻; B₅O₈⁻²; and BO₂⁻; R₁, R₂, R₃ and R₄ are selected from i) substituted or unsubstituted alkyl groups containing in the range of from 1 to 20 carbon atoms or ii) substituted or unsubstituted alkenyl groups containing in the range of from 1 to 20 carbon atom, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, or 3, depending on the selection of Y; said cellulosic substrates are termite repellant; said cellulosic substrates are in direct or indirect contact with the ground; and said cellulosic substrates are part of a building in any stage of its construction.

33) The composition according to claim 32 wherein Y is BO₃⁻³, and m is 3.

34) The composition according to claim 32 wherein R₁ and R₂ are independently chosen from alkyl groups having from 1 to 3 carbon atoms, and R₃ and R₄ are independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups.

35) The composition according to claim 32 wherein R₁ and R₂ are methyl group and R₃ and R₄ are independently selected from unsubstituted alkyl groups containing from 8 to 16 carbon atoms.

36) The composition according to claim 35 wherein one of R₃ or R₄ is an unsubstituted alkyl group containing from 8 to 10 carbon atoms, and the other of R₃ or R₄ is an unsubstituted alkyl group containing from 12 to 14 carbon atoms.

37) The composition according to claim 35 wherein one of R₃ or R₄ is an unsubstituted alkyl group containing from 8 to 14 carbon atoms, and the other of R₃ or R₄ is an unsubstituted alkyl group containing from 13 to 16 carbon atoms.

38) The composition according to claim 32 wherein R₃ and R₄ contain a different number of carbon atoms.

39) The composition according to claim 32 wherein said at least one quaternary ammonium compound has the formula: 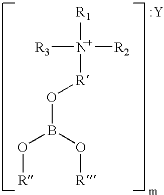
wherein Y is selected from H₂BO₃⁻; HBO₃⁻²; BO₃⁻³; B₄O₇⁻²; HB₄O₇⁻; B₃O₅⁻; B₅O₈⁻²; and BO₂⁻; R″ and R′″ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and R₁, R₂, and R₃ are selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; m is 1, 2, or 3, depending on the selection of Y; R′ is an alkyl group having from 1-10 carbon atoms, and R″ and R′″ are independently selected from unsubstituted alkyl groups having from 1-20 carbon atoms.

40) The composition according to claim 32 wherein said composition is part of a building in any stage of its construction.

41) The composition according to claim 32 wherein said composition is flame retardant.

42) The composition according to claim 40 wherein said quaternary ammonium compound has been applied to said cellulosic substrate with a metal coupler free solution comprising said quaternary ammonium compound.

43) A building comprising cellulosic substrates wherein said building is present in an environment conducive to the presence, growth, and/or sustainability of termites and wherein the cellulosic substrates of the building comprise in the range of from about 1 to about 30 wt. %, based on the cellulosic substrate, of at least one quaternary ammonium compound having the formula: 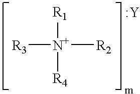
wherein Y is selected from H₂BO₃⁻; HBO₃⁻²; BO₃⁻³; B₄O₇⁻²; HB₄O₇⁻; B₃O₅⁻; B₅O₈⁻²; BO₂⁻; PO₄⁻³, HPO₄⁻², H₂PO₄⁻, P₂O₇⁻⁴, P₃O₁₀⁻⁵, PO₃⁻; CO₃⁻²; HCO₃⁻; [CO₂⁻]ₙR₅; and combinations thereof; R₁, R₂, R₃ and R₄ are selected from i) substituted or unsubstituted alkyl groups containing in the range of from 1 to 20 carbon atoms or ii) substituted or unsubstituted alkenyl groups containing in the range of from 1 to 20 carbon atom, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, or 3, depending on the selection of Y.

44) The building according to claim 43 wherein said cellulosic substrates are in direct or indirect contact with the ground.

45) The building according to claim 43 wherein Y is BO₃⁻³, and m is 3.

46) The building according to claim 45 wherein said cellulosic substrates are termite repellant.

47) The building according to claim 43 wherein R₁ and R₂ are independently chosen from alkyl groups having from 1 to 3 carbon atoms, and R₃ and R₄ are independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups.

48) The building according to any claim 43 wherein R₁ and R₂ are methyl groups and R₃ and R₄ are independently selected from unsubstituted alkyl groups containing from 8 to 16 carbon atoms.

49) The building according to claim 43 wherein R₃ and R₄ contain a different number of carbon atoms.

50) The building according to claim 43 wherein one of R₃ or R₄ is an unsubstituted alkyl group containing from 8 to 10 carbon atoms, and the other of R₃ or R₄ is an unsubstituted alkyl group containing from 12 to 14 carbon atoms.

51) The building according to claim 43 wherein one of R₃ or R₄ is an unsubstituted alkyl group containing from 8 to 14 carton atoms, and the other of R₃ or R₄ is an unsubstituted alkyl group containing from 13 to 16 carbon atoms.

52) The building according to claim 43 wherein one of R₃ or R₄ is an unsubstituted alkyl group containing 14 carbon atoms, and the other of R₃ or R₄ is an unsubstituted alkyl group containing from 14 to 16 carbon atoms.
